(19) United States
(12) Patent Application Publication
(10) Pub. No.: US 2002/0138218 A1
(43) Pub. Date: Sep. 26, 2002

(54) Method and device for robust pattern recognition

(76) Inventor: Richard Ernest Williams, Lake Mary, FL (US)

Correspondence Address: Williams Family Trust B,, Richard K. Williams, Trustee, 1710 Bluegate Court, Fort Collins, CO, 80526, US

(21) Appl. No.: 09/813,596

(22) Filed: Mar. 22, 2001

(51) Int. Cl. G06F 19/00

(52) U.S. Cl. 702/60

(57) ABSTRACT

Signatures of entities to be recognized are assumed to be temporal scans of energy. They are converted to digital descriptor sets. Noise disruptions of signals can produce extra descriptors, losses of descriptors, and various deleterious distortions. Unique one-many descriptor matching and resulting descriptor enhancements greatly improve recognitions in hostile environments. Templates derived from entities are group-edited to increase auto-correlation scores (correct recognitions), while decreasing cross-correlation scores (incorrect recognitions). Recognitions become far more robust.

### TECHNICAL FIELD

The present invention relates to recognition of a scanned signal pattern subjected to disruptions.

### BACKGROUND ART

Scanning methods are widely used in many disciplines to convert dimensional patterns to time, or temporal, functions. Examples include X-rays, Computer-Aided-Tomography (CAT), forensics, TV imaging devices, spectrometry, chromatography; SONAR, RADAR, and many other systems. A pattern recognizer's task is to detect and identify entities revealed by energy perturbations encountered during a scan. Signatures of interest often exhibit interfering and changing temporal patterns. Amplitudes may arbitrarily change. Interception strengths may change with radiation conditions, substance concentrations, collection methods, equipment artifacts, etc. Signature components may disappear completely when a signal becomes weak. Disruptive components from extraneous sources may arise, and many other variations may occur. Accordingly, current recognition devices commonly require high signal-to-background ratios to reliably recognize patterns.

Pattern research usually treats a pattern as a set of points, or ‘descriptors’, in dimensioned space. Patterns are assigned to a class when some sort of mean-square distance between the pattern's descriptors and those of a specific template falls sufficiently below similar distances to other templates. An advantage to the approach is that it has a well-established mathematical foundation. In all but specialized or highly simplified cases, however, pattern descriptors in signals may appear or disappear. Locations frequently will be indefinite. Space dimensionality can change in unpredictable manners. Static analytical methods are limited.

When attempting to identify a changeable pattern, the recognition process cannot be restricted to a simple template-matching procedure. A human, for example, has been conditioned to subconsciously grade available cues such as spatial ratios, colors, etc., in comparing an image to one in memory. Cues most important to proper recognition are emphasized. Aspect angles can vary widely, and there is no exact measuring rod in the brain. In a recognition process, as opposed to observation, sensory cues assume dynamically varying degrees of importance, or weights. A decision 20 is based upon the ‘comfort’ with which an emerging set of cues resembles a set in memory. Recognition rules themselves thus dynamically vary, and are affected by factors not intrinsically contained in a pattern.

Current art most often employs a well-ordered pattern space, usually of two dimensions. Boolean rules typically are applied to quantized regions in that space. Speech recognition, for example, frequently uses zones of frequency and time. Character recognition uses quantized Cartesian coordinates. Such methods are vulnerable to entropy in the form of noise disruptions or spatial distortions.

### SUMMARY OF THE INVENTION

Template Generation

The present invention modifies templates representing entities to be recognized. Modifications result in more robust recognition in the presence of noise and other disruptions. A pattern to be recognized is scanned to produce a temporal function. If essentially continuous, the function is transformed by a selected mathematical process to produce favorable types and numbers of descriptors. Each descriptor, typically in the form of a number, defines a temporal event such as a relative time and direction of a zero crossing. A group of descriptors derived from an entity-produced pattern is stored as an initial template. Similar processes provide initial templates for each entity of interest.

Once a set of initial templates has been established, the entire set is subjected to a unique group edit that seeks cross-correlations among all paired combinations. Degrees of cross-correlation are scored. The pair exhibiting a highest score is considered the most likely to produce a recognition error, and is selected for revisions.

Descriptors that can improve recognition accuracies are found and attached to appropriate templates. Each time a revision has occurred, the revised template is substituted for the old, and the search-and-revise sequence repeated. If no further improvement is possible, the user is informed, and the edit discontinued. Otherwise the edit process continues until all scores fall below a preset threshold. Each final template has been influenced by all other templates.

Pattern Processing

Intercepted-signal patterns to be recognized are transformed to produce descriptors in the manner used to create initial templates, but are not subjected to the template-modification process. A recognition decision conforms to the highest degree of match, or score, produced by comparison to an edited template. A score is derived in the current invention as follows:

A first descriptor of a first edited-template is compared to every signal descriptor in a template-to-signal one-many correspondence. If a match occurs, a score is increased. If no match is found, the score is decreased.

A similar procedure is followed for each edited-template descriptor. If, for example, there are fourteen template descriptors and sixteen signal descriptors, a total of 14×16, or 224 descriptor-match attempts are made. The template-to-signal many-one process has the unique property of accommodating length and/or descriptor-order changes in a signal pattern corrupted by spurious pulses.

If the number of descriptors in a particular template had been increased by the edit process, the number of descriptor match-attempts would increase for that template. The scores of proper recognitions rise (more matches), and those of improper recognitions drop (more errors). Thus the one-many descriptor comparison process combined with group edit increases auto-correlation (proper recognition) scores, lowers cross-correlation (improper recognition) scores, and greatly improves noise immunity. The edit causes measurement criteria to differ among patterns.

It is therefore an object of the present invention to provide a method of generating improved descriptor sets for scanned patterns.

Another object of the invention is to provide a method of generating a recognition rule peculiar to a pattern class.

Another object of the invention is to provide a one-many descriptor comparison procedure between a template and signal to reduce effects of noise disruptions.

Another object of the invention is to provide a method and apparatus for editing a group of templates to increase auto-correlations and decrease cross-correlations among patterns.

Yet another object of the invention is to provide a method and apparatus for controlling the significance of a selected descriptor within a pattern cipher.

Still another object of the invention is to provide a method and apparatus for scoring a degree of match between a pair of templates.

Yet another object of the invention is to provide a method and apparatus for pattern recognition that is robust under noise disruptions.

### BRIEF DESCRIPTION OF THE DRAWINGS

The features and advantages of the present invention will be more clearly understood when the detailed description of a preferred embodiment described below is considered in conjunction with the drawings provided in which:

FIG. 1 is a block diagram of apparatus for recognizing a pattern in accordance with the present invention;

FIG. 2 is a representation of a typical temporal scan of an entity showing zero-crossing descriptor points in accordance with the present invention;

FIG. 3 is a cipher produced by the waveform of FIG. 2;

FIG. 4 is the cipher of FIG. 3 paired with another cipher demonstrating descriptor cross-correlations;

FIG. 5 represents the ciphers of FIG. 3 converted to templates after a group edit; and

FIG. 6 is the waveform of FIG. 2 showing the effect of a noise pulse.

### DETAILED DESCRIPTION OF THE PREFERRED EMBODIMENTS

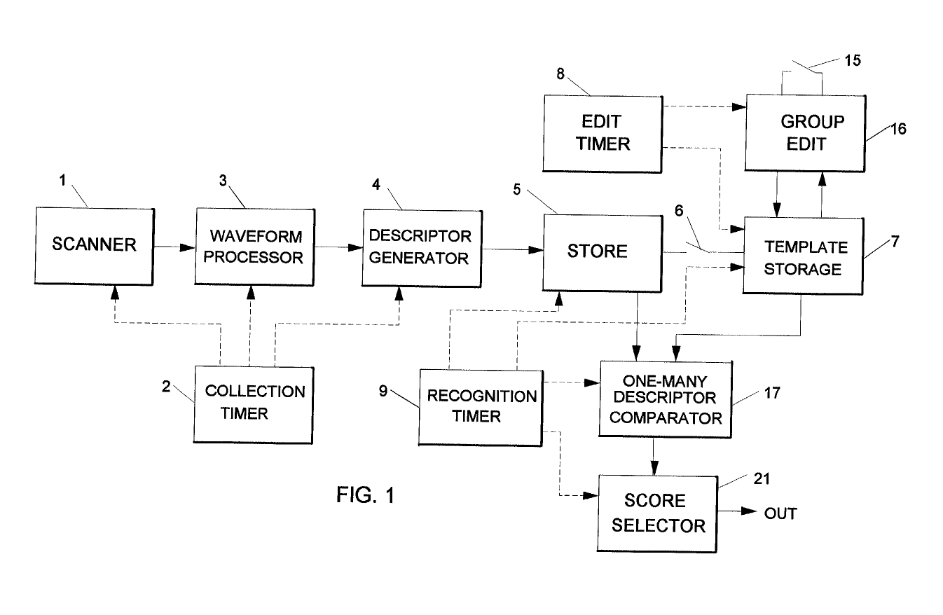

Referring to the block diagram of FIG. 1, SCANNER 1 is a generic scanning stage representing those found in many existing systems. The function of SCANNER 1 is to convert energy functions derived from entities such as distance-related terrain features, chemical substances, boats or aircraft, electromagnetic signals, sounds, etc., into electrical temporal functions. Examples abound. TV raster scans, RADAR, SONAR, X-ray imaging, spectrometers, seismic sensors, and many other applications produce such energy functions. In most cases an entity reflects, refracts, absorbs, or otherwise modulates, energy from an irradiating source such as sunlight, sound, heat, electromagnetic radiation, etc., to produce its identifying energy function.

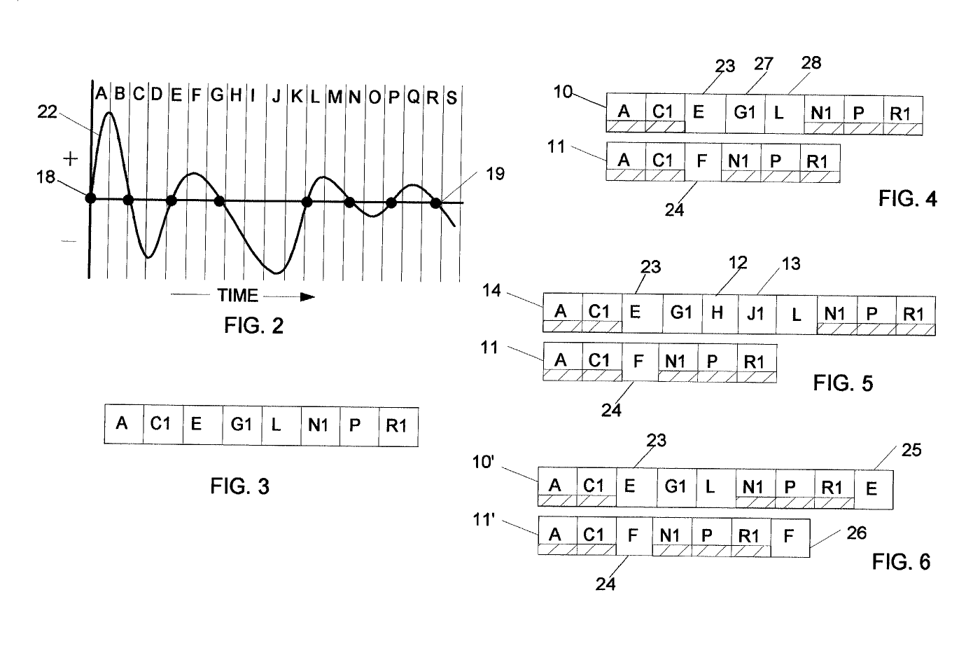

SCANNER 1 is driven by COLLECTION TIMER 2 which assures that WAVEFORM PROCESSOR 3 and DESCRIPTOR GENERATOR 4 are synchronized with each scan. Timing connections are shown dashed in the figure. The scanned function can thereby be resolved into a number of measurable time intervals, or cells, as shown in FIG. 2.

WAVEFORM PROCESSOR 3 will produce an undulating waveform 22 corresponding to an energy function of a scanned entity. Waveforms in a preferred embodiment of the invention have shapes that will produce numerous zero-axis crossings. Circuits in PROCESSOR 3 are selected to produce stable zero-axis crossings such as 18 and 19. Each crossing's direction and location is a ‘descriptor’ of the pattern produced by the scan. Circuits in PROCESSOR 3 may range from simple amplifiers to orthogonal-series expandors, frequency-selective elements, differentiators, or other transformation devices to provide a suitable number of descriptors. Details of various transformations are well-known and fully described in the literature. Once a transformation is selected, it must be consistently applied in the invention.

Referring to FIG. 2, a scan duration is divided into identifiable cells. For expository purposes, they are given alphabetical labels. A symbol such as the numeral one is attached to a descriptor label to indicate direction of crossing. In the example, the numeral indicates a plus-to-minus crossing. Under such rules, descriptors for the waveform of FIG. 2 are shown in FIG. 3. Such an entire group will be called a “cipher” hereafter. It is clear that other symbols such as hexadecimal or binary notations could also have been used to create ciphers.

DESCRIPTOR GENERATOR 4 of FIG. 1 converts the waveform of FIG. 2 into the notational form of FIG. 3. GENERATOR 4 strobes the waveform of FIG. 2 at cellular intervals and tests for polarities. Polarity changes and directions are expressed as symbols as described. The resulting cipher in digital form is placed into STORE 5 of FIG. 1.

When an initial template representing the entity that had produced the cipher of FIG. 3 is desired, switch 6 of FIG. 1 is closed to store the cipher in TEMPLATE STORAGE 7. The cipher transfer does not necessarily have to be synchronized with the real-time scanning process. Transfer can be timed by an independent clock such as EDIT TIMER 8 or RECOGNITION TIMER 9. In a preferred embodiment TIMERS 2, 8, and 9 are derived from a single stable master clock, a widespread practice in personal-computer design.

A scoring system is required for recognition. For explanatory purposes, if a template descriptor and a signal descriptor of an entity match, they will be assumed to increase the recognition score for that entity by one. If not, they will be assumed to decrease the score by one. Accordingly, if all eight descriptors of FIG. 3 were compared to a completely matching template, an entity score of eight would result. A single mismatch would drop the score to seven minus one, or six.

An entity different from the one producing FIG. 3 may produce one or more descriptors that match those of FIG. 3. Assume, for example, that the waveform of FIG. 2 were derived from a spectral scan of an aqueous solution of a substance to be recognized. If an aqueous solution of a different substance were to be separately recognized, its waveform would likely produce water-produced descriptors that would match some in FIG. 3. If water itself were to be recognized, all of its descriptors could possibly fall into the FIG. 3 cipher. An overlapping, or cross-correlation, situation is depicted in FIG. 4 where matched descriptors are shaded.

Assume that switch 6 of FIG. 1 had been closed to store the cipher of FIG. 3 as upper cipher 10 of FIG. 4. Cipher 10 then is an initial template representing the waveform of FIG. 2. If each of the six descriptors in lower cipher 11 were compared to a sequence of all eight upper cipher 10 descriptors, five would find a match. A score of five minus one, or four, would result. If, on the other hand, upper cipher 10 were a signal pattern and lower cipher 11 a template, a similar comparison process would produce three mismatches and a score of five minus three, or two. Cross-correlations thus do not always commute under the rules. A to B is not necessarily the same as B to A, primarily because the number of descriptors can differ. Employing a descriptor sum as a recognition cue is dangerous in most cases because noise pulses can easily change it.

Templates are usually generated under controlled conditions. They are relatively noise-free. In contrast, signal patterns often vary greatly in length and strength. They are frequently corrupted by noise pulses and missing descriptors. The recognition procedure of the invention acknowledges that unbalance, and exploits superior template stability to greatly reduce noise effects.

The invention selects a one-many correspondence from template to signal to improve recognition capabilities. Thus, a first template descriptor is compared to all signal descriptors, a second template descriptor is compared to all signal descriptors, etc. If the signal has been corrupted by the addition of noise pulses or is missing weak descriptors, any disorder in its sequence becomes irrelevant. The process continues until all template descriptors have been able to seek a match. If non-matching noise pulses are encountered in the process, they are ignored (with no penalty). On the other hand, if a template descriptor fails to find its match anywhere in a signal descriptor set, the score is lowered.

An example is shown in FIG. 5. The Figure is identical to FIG. 4, except that a pair of noise-produced zero-crossings 12,13 have been inserted into cipher 14, representing a disrupted signal cipher of FIG. 3. When lower cipher 11 (a template) is tested in a one-many correspondence to cipher 14, the score is five minus one, or four. The score is exactly the same as in the corresponding uncorrupted case of FIG. 4. Signal length change and noise content were ignored.

DESCRIPTOR COMPARATOR 17 of FIG. 1 provides the described template-to-signal, one-to-many correspondence. A reverse procedure will not work. In that case a noise pulse in the signal would be treated as a true descriptor. When unable to find a match anywhere in the template, the pulse would trigger a penalty. Noise pulses would incorrectly affect scores.

Discussions relative to FIG's 4 and 5 emphasized the necessity of always designating a ‘template’ cipher and a ‘signal’ cipher. Their roles can be reversed for special purposes. That procedure is exploited in the present invention to greatly reduce incidences of improper recognitions.

Referring to FIG. 1, a group of initial templates can be obtained from entity scans by closing switch 6 and transferring them to TEMPLATE STORAGE 7. It is obvious to those skilled in the art that such templates can alternatively be placed in archival files and retrieved when desired. Once a set of initial templates has been placed into STORAGE 7, the entire set can be subjected to a unique group edit by closing switch 15 and activating GROUP EDIT 16. EDIT 16 generates a series of template-to-template comparisons. The non-commutating nature of cross-correlations means that if N entities are in a population, N(N−1) possible entity pairings (excluding identities) can occur. For example, if ten entities are involved, ninety possible cross-correlations can occur.

EDIT 16 subjects every pair of templates in the set to cross-correlation tests in which one member is treated as a template and the other as a ‘signal’. Scores are found in the manner described relative to FIG. 4. The pair exhibiting a highest score is considered the most likely to produce a recognition error, and is selected for revisions.

Assume that the cipher pair of FIG. 4 comprises a pair of templates and has been selected because its cross-correlation score from ‘signal’ 11 to ‘template’ 10 was four. ‘Template’ member 10 of the pair is first examined to find if it has a descriptor that does not appear in ‘signal’ member 11. In FIG. 5, descriptors 23, 27, and 28 are found. Any of the three could be selected, but assume that descriptor 23 is chosen. Descriptor 23 is then enhanced, preferably by simply repeating it as descriptor 25 shown in FIG. 6. Descriptor 25 in ‘template’ 10′ is, like descriptor 23, unable to find a match in ‘signal’ 11′. The score is therefore reduced by one. ‘Template’ and ‘signal’ roles can then be reversed and a similar test applied.

If no disjunct descriptors had been found in either case, the templates would have been identical. No pattern separation would be possible for the pair. The user would be informed.

In the example of FIG. 6, descriptor 23 was found and enhanced by inserting it again as descriptor 25. Upon a reversal test, descriptor 24 was enhanced by inserting descriptor 26. The ciphers of FIG. 6 represent edited templates, as opposed to the initial templates of FIG. 4.

The score for template 10 of FIG. 4 and the signal cipher of FIG. 3 would be eight, a complete match. The same score for edited template 10′ of FIG. 6 rises to nine. Thus, the described method raises auto-correlation scores while lowering incorrect-recognition (cross-correlation) scores.

When one or more disjunct descriptors have been found and enhanced in a selected pair, the revised ciphers must be substituted for the originals before additional editing can proceed. Since a group edit operates upon interactions among all ciphers, they must constantly be updated. Following update, the group edit again seeks a highest-score pair. The process is repeated until all scores fall below a preset threshold, or no further improvement can be found. The template group edit is then over.

For clarity, score changes have been described in unit increments. Increments were assumed uniform among descriptors. A preferred embodiment employs higher increments, such as two or three, for corrective descriptors 25, 26 of FIG. 6. The higher scoring weights tend to increase auto-correlations and decrease cross-correlations more rapidly during an edit process. They also reduce the number of corrective descriptors required in revised templates.

During a recognition procedure, three options are available. If special scoring weights are not imposed, multiple corrective descriptors can be inserted, and treated by SCORE SELECTOR 21 of FIG. 1 in the manner of all other descriptors. Descriptor 25 of FIG. 6, for example, may be inserted several times. A second option is to identify corrective descriptors by insertion locations imposed by GROUP EDIT 16 of FIG. 1, and have SELECTOR 21 assign appropriate scoring weights during the scoring process. As a third option, identifying or score-weighting symbols can be inserted by EDIT 16 into corrective descriptors. SELECTOR 21 can detect the symbols and adjust the score accordingly. Regardless of the option selected, appropriate scoring weights are applied and employed during a highest-score search by SELECTOR 21. A recognition is made when an input signal cipher has been compared to all edited templates by COMPARATOR 15 and SELECTOR 21 and has produced a highest score.

For simplicity of explanation, the number of cells, scores, and ciphers have been held to very low numbers. It is to be understood that in practice the numbers are often immensely greater.

Thus, while the invention has been particularly shown and described with reference to preferred embodiments thereof, it will be understood to those skilled in the arts that various changes in forms and details may be made therein without departing from the spirit and scope of the invention.

What is claimed as new and desired to be protected by Letters Patent is set forth in the appended claims:

I claim:

1. A method of generating a cipher for recognition of an energy function derived from an entity, comprising the steps of:
(a) scanning said energy function to produce a temporal waveform with a plurality of zero crossings;
(b) dividing said waveform into a plurality of indexed temporal cells;
(c) generating descriptors identifying temporal-cell indices and crossing polarities at zero crossings; and
(d) combining said descriptors to generate said cipher.

2. The method of claim 1 which comprises the further steps of:
(e) copying a plurality of said ciphers into initial templates;
(f) performing a one-many comparison between descriptors in a first template and descriptors in a second template;
(g) computing a cross-correlation score between said first template and said second template, wherein said score is increased when compared descriptors in said templates match, and is decreased when compared descriptors in said templates do not match;
(h) selecting a pair of said initial templates exhibiting a highest cross-correlation score;
(i) identifying a disjunct descriptor that resides in only a single member of said pair; and
(j) increasing a scoring weight of said disjunct descriptor in said single member.

3. The method of claim 2 which comprises the further step of:
(j) increasing a scoring weight of said disjunct descriptor by repeating said disjunct descriptor in said member.

4. The method of claim 2 which comprises the further steps of:
(k) placing said disjunct descriptor at a selected location in said member; and
(l) increasing a scoring weight at said location.

5. The method of claim 2 which comprises the further steps of:
(m) attaching a symbol to said disjunct descriptor; and
(n) during a scoring process increasing the scoring weight of a descriptor carrying said symbol.

6. The method of claim 2 which comprises the further steps of:
(o) inserting said enhanced descriptor into said single member; and
(p) repeating steps (h), (i), and (j) of claim 2 with said enhanced-descriptor insertions until said highest cross-correlation score cannot be further reduced.

7. A method of determining the degree to which a cipher derived from an unknown entity matches that of a known entity, comprising the steps of:
(a) performing one-many comparisons between each descriptor in an edited template carrying an enhanced descriptor and representing said known entity, and every descriptor in said cipher;
(b) accruing a score in which matching descriptors in said comparisons cause said score to increase and non-matching descriptors cause said score to decrease, wherein said score represents a degree of match between said unknown entity and said known entity.

8. A device for producing a temporal waveform in response to an energy signal derived from an entity comprising: waveform processing means to produce a zero crossing in said waveform;
timing means to provide an index of said zero crossing;
descriptor-generating means to combine an indicator of crossing direction with said zero crossing in a descriptor; and
combining means to merge a plurality of said descriptors into a cipher representing said entity.

9. The device of claim 8 further comprising:
template-storing means to store a plurality of said ciphers as initial templates representing said entities.

10. The device of claim 9 further comprising:
one-many comparison means to compare each descriptor in a first initial template to every descriptor in a second initial template; scoring means to increase a score when said comparison finds a descriptor match, and to decrease said score when descriptors do not match; and
summing means to combine said descriptor scores into a cross-correlation measure between said first and second initial templates.

11. The device of claim 10 further comprising:
first selection means to identify a pair of said initial templates exhibiting a highest cross-correlation measure;
second selection means to identify a disjunct descriptor residing in only one member of said pair; and
weight-scaling means to assign an increased scoring weight to said disjunct descriptor.

12. The device of claim 11 further comprising:
stepping means to repeat said pair selection, said disjunct-descriptor selection, and said weight-scaling until said highest cross-correlation measure does not further reduce; and storage means to retain all final templates as representations of said entities.

13. A device to recognize a cipher representing an energy signal derived from an entity comprising:
an edited entity template;
one-many comparison means to compare each descriptor in said edited template to every descriptor in said cipher;
scoring means to increase a score when said comparison finds a descriptor match, and to decrease said score when descriptors do not match; and
summing means to combine said descriptor scores into an auto-correlation measure between said cipher and said edited template, whereby said measure comprises a degree of recognition.
